(19) United States
(12) Patent Application Publication
(10) Pub. No.: US 2013/0257175 A1
(43) Pub. Date: Oct. 3, 2013

(54) SEMICONDUCTOR DEVICE HAVING COMPENSATION CAPACITOR TO STABILIZE POWER-SUPPLY VOLTAGE

(71) Applicant: ELPIDA MEMORY, INC., Tokyo (JP)

(72) Inventor: Kazuhiro YOSHIDA, Tokyo (JP)

(73) Assignee: ELPIDA MEMORY, INC., Tokyo (JP)

(21) Appl. No.: 13/793,923

(22) Filed: Mar. 11, 2013

(30) Foreign Application Priority Data
Mar. 28, 2012 (JP) 2012-072868

(51) Int. Cl. H02J 4/00

(52) U.S. Cl. CPC H02J 4/00
USPC 307/109

(57) ABSTRACT

The semiconductor device includes a capacitance element connected to a first power-supply line via a first switch element, and to a second power-supply line via a second switch element; and a control circuit that controls the first and second switch elements. The control circuit turns the first switch element ON during a first period (voltage is supplied only to the first power-supply line), while turning the second switch element ON during a second period (voltage is supplied to both the first and second power-supply lines).

### BACKGROUND OF THE INVENTION

1. Field of the Invention

The present invention relates to a semiconductor device, and particularly to a semiconductor device that is equipped with a compensation capacitor to stabilize power-supply voltage.

2. Description of Related Art

In a semiconductor device, a capacitance element may be provided to stabilize power-supply voltage. What is illustrated in Japanese Patent Application Laid-Open No. 2009-124470 is an example in which a capacitance element 111 is connected to a power-supply line 103 of a semiconductor device having a power gating function. The power-supply line 103 is connected to a power-supply line 101 via a switch unit 112. During a period in which power-supply potential needs to be supplied to a circuit 110, the power-supply line 103 is connected to the power-supply line 101. When the circuit 110 operates, switching of a transistor causes power-supply noise. The power-supply noise propagates via the power-supply lines 103 and 101, and may lower an operation margin.

The capacitance element 111 is provided to decrease power-supply noise on the power-supply line 103. The capacitance element 111 will be referred to as “compensation capacitor.”

As described above, the power-supply line 103 is connected to the power-supply line 101 via the switch unit 112. Therefore, when the switch unit 112 is ON, the capacitance element 111 is charged. However, during a period in which the switch unit 112 is OFF, the capacitance element 111 is not being charged. When the switch unit 112 is turned ON after having been OFF, a voltage begins to be supplied to the power-supply line 103, and the capacitance element 111 begins to be charged at the same time. Therefore, it takes time to raise the potential of the power-supply line 103 to a desired potential after the switch unit 112 is turned ON from OFF. While the capacitance element 111 has the advantage that the potential of the power-supply line 103 is stabilized, the capacitance element 111 has the disadvantage that the time required for the power-supply line 103 to reach a desired potential (referred to as “standby time,” hereinafter) is delayed. Thus, in some cases, the compensation capacitor may not be employed in practice.

### SUMMARY

In one embodiment of the present invention, there is provided a semiconductor device that includes: first and second power-supply lines; a first switch element coupled between the first and second power-supply lines; a capacitor element; a second switch element coupled between the second power-supply line and the capacitor element; and a first circuit electrically connecting the capacitor element to the first power-supply line when the first and second switch elements are in an OFF state.

In another embodiment, there is provided a semiconductor device that includes: a capacitor element coupled to a first power-supply line via a first switch element and coupled to a second power-supply line via a second switch element; and a control circuit controlling the first and second switch elements. The control circuit turns the first switch element ON during a first period to connect the first power-supply line to the capacitor element, the first period being in which a power-supply voltage is supplied to the first power-supply line and is not supplied to the second power-supply line. The control circuit turns the second switch element ON during a second period to connect the second power-supply line to the capacitor element, the second period being in which the power-supply voltage is supplied to the first and second power-supply lines.

In still another embodiment, there is provided a semiconductor device that includes: a capacitor element coupled to a first power-supply line via a resistance element, and coupled to a second power-supply line via a second switch element; and a control circuit controlling the second switch element. The control circuit turns the second switch element OFF during a first period to disconnect the second power-supply line from the capacitance element, a power-supply voltage being supplied to the first power-supply line and being not supplied to the second power-supply line in the first period. The control circuit turns the second switch element ON during a second period to connect the second power-supply line to the capacitance element, the power-supply voltage being supplied to the first and second power-supply lines in the second period.

According to the present invention, the delay of the standby time can be suppressed by providing the compensation capacitor.

### BRIEF DESCRIPTION OF THE DRAWINGS

FIG. 1 is a block diagram of a semiconductor device according to an embodiment of the present invention;

FIG. 2 is a diagram showing the capacitance control circuit and peripheral circuits thereof according to a first embodiment of the present invention;

FIG. 3 is a chip layout diagram of the semiconductor device shown in FIG. 1;

FIG. 4 is a layout diagram of an area around the capacitance control circuit;

FIG. 5 is a sequence chart showing a process of controlling the switches;

FIG. 6 is a schematic top view showing a first configuration example of the capacitance element;

FIG. 7 is a schematic top view showing a second configuration example of the capacitance element;

FIG. 8 is a schematic top view showing a third configuration example of the capacitance element;

FIG. 9 is a schematic top view showing a first connection example of the capacitance element having the configuration shown in FIG. 6 with the switch elements SW1 and SW2;

FIG. 10 is a schematic top view showing a second connection example of the capacitance element having the configuration shown in FIG. 6 with the switch elements SW1 and SW2;

FIG. 11 is a schematic top view showing a third connection example of the capacitance element having the configuration shown in FIG. 6 with the switch elements SW1 and SW2;

FIG. 12 is a diagram showing the capacitance control circuit and peripheral circuits thereof according to a second embodiment of the present invention;

FIG. 13 is a schematic top view showing a connection example of the capacitance element having the configuration shown in FIG. 6 with the switch elements SW1, SW2 and SW3;

FIG. 14 is a diagram showing the capacitance control circuit and peripheral circuits thereof, according to a third embodiment; and

FIG. 15 is a block diagram of the semiconductor device in modification example.

### DETAILED DESCRIPTION OF THE EMBODIMENTS

Hereinafter, with reference to the accompanying drawings, preferred embodiments of the present invention will be described in detail. As a semiconductor device, DRAM (Dynamic Random Access Memory) will be described as a target of the present embodiments. However, the present invention is not limited to DRAM.

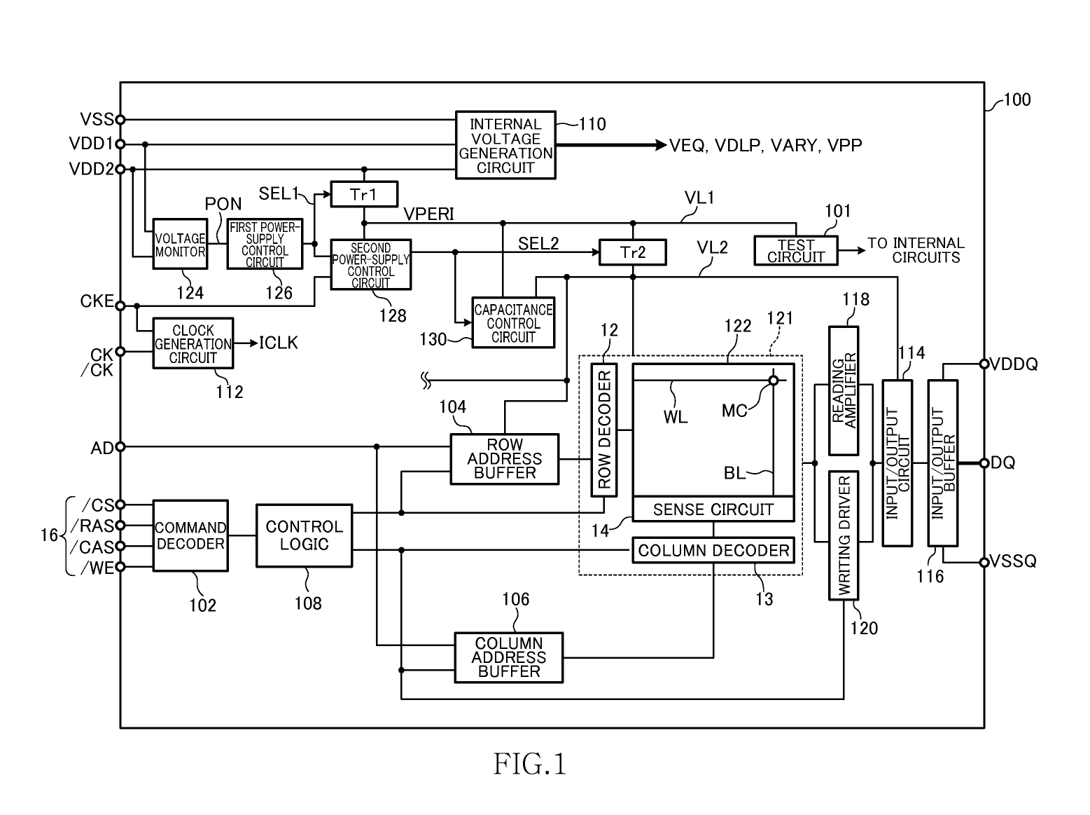

FIG. 1 is a block diagram of a semiconductor device 100. In the semiconductor device 100, a memory cell array 122 in a memory region 121 is provided with a plurality of word lines WL and a plurality of bit lines BL, which cross each other. At intersection points of the lines, memory cells MC are disposed. A row decoder 12 selects a word line WL. A column decoder 13 selects a bit line BL. Each of the bit lines BL is connected to a corresponding one of sense amplifiers included in a sense circuit 14. A bit line BL selected by the column decoder 13 is connected to a reading amplifier 118 and a writing driver 120 via a sense amplifier. The reading amplifier 118 and the writing driver 120 are connected to an input/output buffer 116 via an input/output circuit 114. The input/output circuit 114 and the input/output buffer 116 perform inputting and outputting of data via a data terminal DQ. To the input/output buffer 116, external voltages VDDQ and VSSQ are supplied.

To the semiconductor device 100, various signals, including the following, are supplied: clock signals CK and /CK; a clock enable signal CKE; and an address signal AD. Moreover, external voltages VDD1, VDD2, and VSS and the like are supplied to the semiconductor device 100. For example, suppose that VDD1 is 1.8(V), VDD2 is 1.2(V), and VSS is 0(V).

The external clock signals CK and /CK are supplied to a clock generation circuit 112. In the present specification, a signal whose name ends with “/” means a low-active signal or an inverted signal of a corresponding signal. Accordingly, the external clock signals CK and /CK are complementary to each other. The clock generation circuit 112 is activated based on the clock enable signal CKE, and generates an internal clock signal ICLK. The internal clock signal ICLK is used as a timing signal for various internal circuits, such as a command decoder 102 and the input/output buffer 116.

The address signal AD is supplied to the row decoder 12 and the column decoder 13 via a row address buffer 104 and a column address buffer 106. The row address buffer 104 is designed to supply a row address to the row decoder 12. The row decoder 12 selects a word line WL on the basis of the row address. The column address buffer 106 is designed to supply a column address to the column decoder 13. The column decoder 13 selects a bit line BL on the basis of the column address.

Command terminals 16 are supplied with signals including: a chip select signal /CS; a row address strobe signal /RAS; a column address strobe signal /CAS; and a write enable signal /WE. The command signals are supplied to the command decoder 102. The command decoder 102 generates internal command signals on the basis of the command signals. The internal command signals are supplied to a control logic 108. The control logic 108 controls how the row address buffer 104, the column address buffer 106, and other circuits operate on the basis of the internal command signals.

External voltages VDD1, VDD2, and VSS are supplied to an internal voltage generation circuit 110. The internal voltage generation circuit 110 generates various internal potentials on the basis of the power-supply potentials VDD1, VDD2, and VSS. The internal potentials generated by the internal voltage generation circuit 110 include a boost potential VPP and an array potential VARY. Incidentally, the external potential VSS is supplied to various internal circuits such as the row address buffer 104 and the memory cell array 122, too.

The external voltage VDD2 is supplied as potential VPERI to the internal voltage generation circuit 110, a test circuit 101, and a power-supply line VL1 via a switch element Tr1. That is, the potential of the power-supply line VL1 is VPERI. In a test mode, the test circuit 101 outputs, to each internal circuit, a test control signal in response to a test command signal, which is among the internal command signals. A voltage monitor 124 detects power-on (power activation) by monitoring the external voltages VDD1 and VDD2, and activate a power-on signal PON (high-active signal). A first power-supply control circuit 126 activates a selection signal SEL1 in response to the power-on signal PON, and turn the switch element Tr1 ON. After the switch element Tr1 is turned ON, the potential VPERI is supplied from the power-supply line VL1 to a second power-supply control circuit 128 and a capacitance control circuit 130.

The second power-supply control circuit 128 activates a selection signal SEL2 at a time when both the selection signal SEL1 and the clock enable signal CKE are activated, and turn a switch element Tr2 ON. After the switch element Tr2 is turned ON, the power-supply line VL1 is connected to the power-supply line VL2, and thus the power-supply line VL1 and the power-supply line VL2 are supplied with the potential VPERI as a result. From the power-supply line VL2, the potential VPERI is supplied to the row address buffer 104, the row decoder 12, and other circuits.

In that manner, the first power-supply control circuit 126 is controlled by the power-on signal PON. The second power-supply control circuit 128 is controlled by the clock enable signal CKE. Needless to say, the clock enable signal CKE, which is used to order enabling of the clock signal CK, is activated on the assumption that the power-on signal is being activated. Even if the power is turned ON, during a period in which the clock enable signal CKE is inactivated, i.e. a period in which the semiconductor device 100 is in a power-down state, the potential VPERI is not supplied to internal circuits such as the row decoder 12. Therefore, power consumption can be reduced after the power is turned ON.

The capacitance control circuit 130 includes a capacitance element C2, which functions as compensation capacitor for the power-supply line VL2. The capacitance element C2 will be detailed later.

### First Embodiment

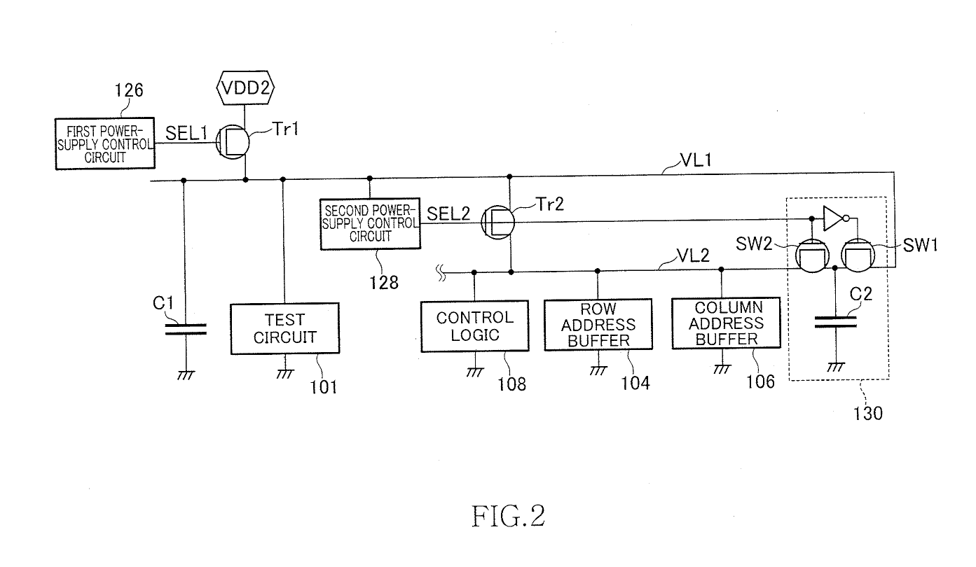

FIG. 2 is the capacitance control circuit 130 and peripheral circuits thereof according to a first embodiment of the present invention. A capacitance element Cl works as compensation capacitor for the power-supply line VIA; the capacitance element C2 in the capacitance control circuit 130 works as compensation capacitor for the power-supply line VL2. The external voltage VDD2 is supplied as potential VPERI to the power-supply line VL1 via the switch element Tr1. The first power-supply control circuit 126 turns the switch element Tr1 ON in response to the activation of the power-on signal PON and selection signal SEL1. The second power-supply control circuit 128 turns the switch element Tr2 ON in response to the activation of the clock enable signal CKE. As a result, the potential VPERI of the power-supply line VL1 is supplied to the power-supply line VL2, too. Various internal circuits such as the control logic 108, the row address buffer 104, the column address buffer 106 and the like are connected to the power-supply line VL2.

The capacitance element C2 is connected to the power-supply line VL1 via a switch element SW1, and to the power-supply line VL2 via a switch element SW2. After the power-on signal PON is activated as the power is turned ON, the potential VPERI is supplied to the power-supply line VL1 via the switch element Tr1. At this time, the clock enable signal CKE is still inactivated, i.e. the selection signal SEL2 is inactivated. Therefore, the switch element SW1 is turned ON, and the switch element SW2 is turned OFF.

Then, after the clock enable signal CKE is activated, the switch element Tr2 is turned ON, the switch element SW1 is turned OFF, and the switch element SW2 is turned ON. The capacitance element C2 is disconnected from the power-supply line VL1, and is connected to the power-supply line VL2. To the power-supply line VL2, the potential VPERI is supplied from the power-supply line VL1. At this time the capacitance element C2 has been already charged. Therefore, the capacitance element C2 does not delay the standby time. The capacitance element C2 that has been already charged works as compensation capacitor to suppress a change in potential of the power-supply line VL2. According to the above configuration, it is possible to maintain the advantage of compensation capacitor in suppressing a change in potential of the power-supply line VL2, as well as to eliminate the disadvantage that the standby time is delayed. Moreover, the capacitance element C2 is charged via the power-supply line VL1 not only immediately after the power is turned ON, but also in a power-down state in which the clock enable signal CKE is inactivated. Therefore, the standby time is not delayed even during a process of transition from the power-down state to an active state in which CKE becomes activated.

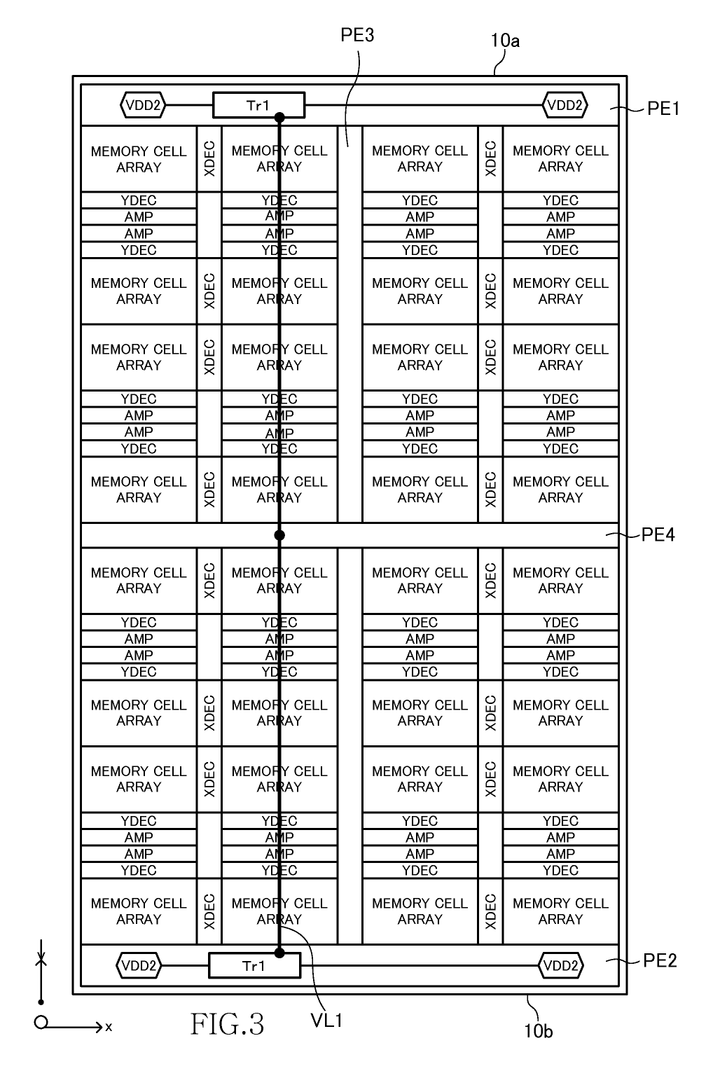

FIG. 3 is a chip layout diagram of the semiconductor device 100 shown in FIG. 1. The semiconductor device 100 of the present embodiment includes a first peripheral circuit region PE1, which is provided along one end portion 10a in a y-direction; a second peripheral circuit region PE2, which is provided along the other end portion 10b in the y-direction; a third peripheral circuit region PE3, which is so provided as to extend in the y-direction in an x-direction central portion; and a fourth peripheral circuit region PE4, which is so provided as to extend in the x-direction in a y-direction central portion. In the first peripheral circuit region PE1, the following are laid out: external terminals such as a bank address terminal, address terminal, and command terminal; and command address-system peripheral circuits such as the command decoder 102. In the second peripheral circuit region PE2, the following are laid out: external terminals such as a data terminal; and data-system peripheral circuits such as the input/output circuit 114 and the input/output buffer 116. In the third peripheral circuit region PE3, various other peripheral circuits are laid out. In the fourth peripheral circuit region PE4, circuits, including the following, are laid out: buffer circuits for various signals, which are supplied from the command address-system peripheral circuits to the data-system peripheral circuits; and the capacitance control circuit 130.

Memory banks are laid out in a region sandwiched between the peripheral circuit regions PE1 and PE2. As shown in FIG. 3, a memory cell array in each memory bank is divided into two in the x-direction. In the regions sandwiched between the memory cell arrays, the row decoders 12 (XDEC) are disposed. Between the memory cell arrays that are adjacent to each other in the y-direction, the column decoders 13 (YDEC) and the sense circuits 14 (AMP) are disposed.

The peripheral circuit regions PE1 and PE2 are provided with power-supply terminals to which the external potential VDD2 is supplied. In the peripheral circuit regions PE1 and PE2, switch elements Tr1 are placed. The external potential VDD2 is supplied to the power-supply line VL1 via the switch elements Tr1. The power-supply line VL1 extends in the y-direction, and is connected to each internal circuit formed in the peripheral circuit region PE3.

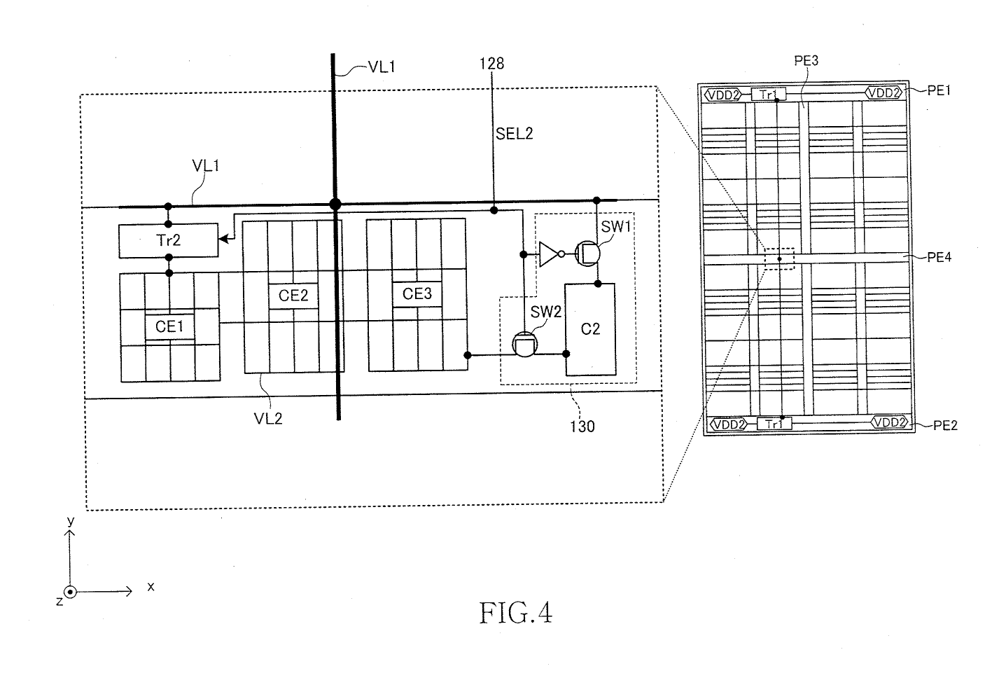

FIG. 4 is a layout diagram of an area around the capacitance control circuit 130. As described above with reference to FIG. 2, the capacitance control circuit 130 is connected to the power-supply line VL1 via the switch element SW1, and to the power-supply line VL2 via the switch element SW2. The switch elements SW1, SW2, and Tr2 all are controlled by the second power-supply control circuit 128. The switch element Tr2 and the capacitance control circuit 130 are formed in the peripheral circuit region PE4. The second power-supply control circuit 128 may also be formed in the peripheral circuit region PE4. The power-supply line VL1 is connected to the mesh-like power-supply line VL2 via the switch element Tr2. Various peripheral circuits CE1 to CE3 are formed near the power-supply line VL2.

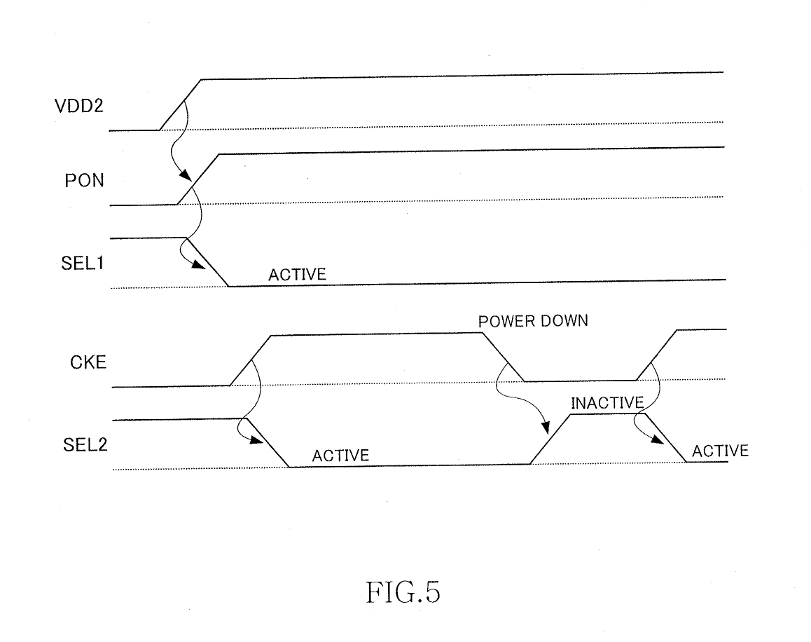

FIG. 5 is a sequence chart showing a process of controlling the switches SW1 and SW2. As shown in FIG. 5, after the power is turned ON, when the external voltage VDD2 rises, the voltage monitor 124 activates the power-on signal PON. The first power-supply control circuit 126 detects the activation of the power-on signal PON, and then activates the selection signal SEL1 (Low Active). In response to the activation of the selection signal SEL1, the switch element Tr1 is turned ON, and the potential VPERI is supplied to the power-supply line VL1 as a result. Since the selection signal SEL2 is inactivated, the switch element SW2 is ON. The capacitance element C2 begins to be charged immediately after the power is turned ON. In this case, the power-on signal PON may be a one-shot pulse signal, which is changed to a low level as the external voltage VDD2 reaches a desired potential.

After the power is turned ON, in response to the activation of the clock enable signal CKE, the second power-supply control circuit 128 activates the selection signal SEL2 (Low Active). As the selection signal SEL2 is activated, the switch element Tr2 is turned ON, and the potential VPERI is supplied to the power-supply line VL2 as a result. In response to the activation of the selection signal SEL2, the switch element SW1 is turned OFF, and the switch element SW2 ON. The capacitance element C2 has been already charged, and will work to suppress a change in potential caused by noise on the power-supply line VL2. Since the switch element SW1 is OFF, it is difficult for noise on the power-supply line VL2 to propagate into the power-supply line VL1.

When the semiconductor device 100 enters a power-down mode (power-save mode) after the power is turned on, the clock enable signal CKE is then inactivated. In response to the inactivation, the selection signal SEL2 is inactivated, disconnecting the power-supply line VL2 from the power-supply line VL1. As a result, the supply of voltage to various circuits such as the control logic 108 that are connected to the power-supply line VL2 is cut off, thereby reducing power consumption. Meanwhile, the switch element SW1 is ON, maintaining the charging state of the capacitance element C2.

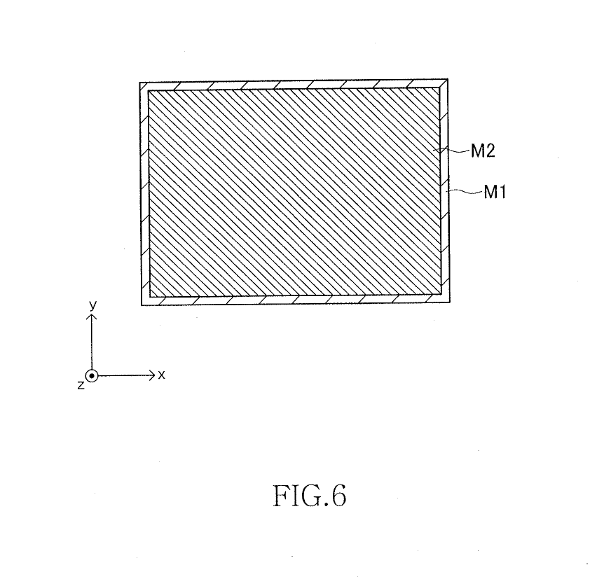

FIG. 6 is a schematic top view showing a first configuration example of the capacitance element C2. The capacitance element C2 of the first configuration example has a structure in which a lower-layer conductive film M1 and an upper-layer conductive film M2 overlap in planar view. In this case, an interlayer insulation film inserted between the conductive films M1 and M2 functions as a capacitance insulation film. In the present example, in a free space of a wiring layer, the capacitance element C2 can be formed.

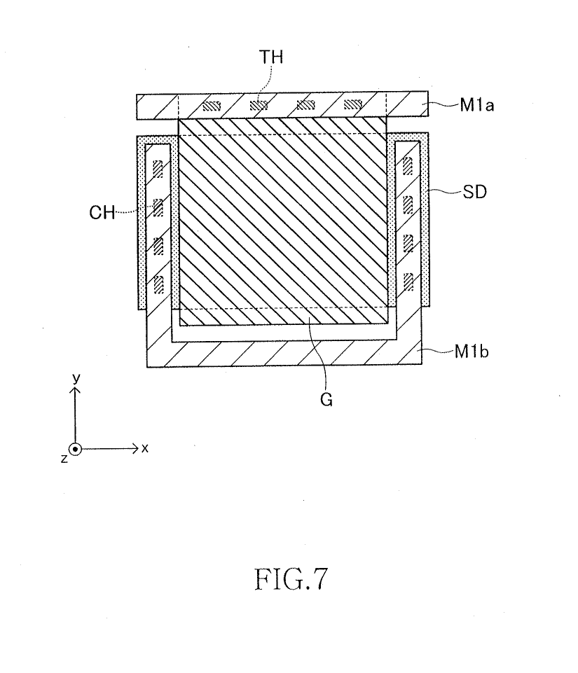

FIG. 7 is a schematic top view showing a second configuration example of the capacitance element C2. The capacitance element C2 of the second configuration example has a structure in which a gate electrode G and a diffusion layer SD overlap in planar view. The gate electrode G is connected to a conductive film M1a via a through-hole conductor TH. The diffusion layer SD is connected to a conductive film M1b via a contact-hole conductor CH. In this case, a gate insulation film inserted between the gate electrode G and the diffusion layer SD functions as a capacitance insulation film. In the present example, in a free space of a semiconductor substrate, the capacitance element C2 can be formed.

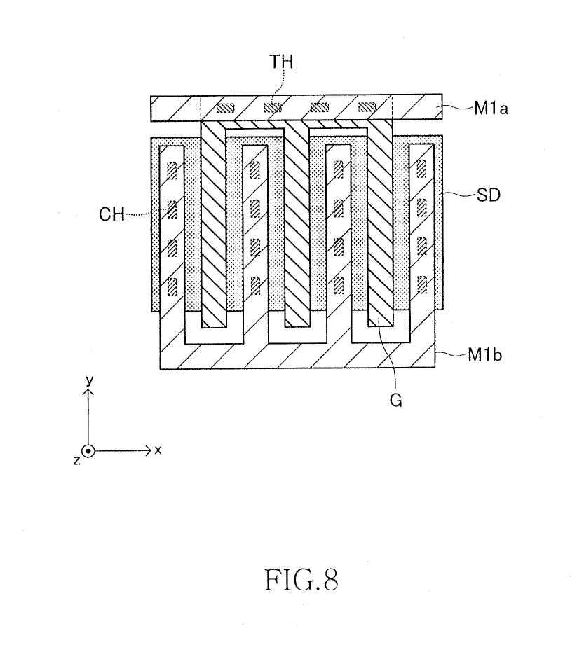

FIG. 8 is a schematic top view showing a third configuration example of the capacitance element C2. The third configuration example is different from the second configuration example in that the diffusion layer SD and the gate electrode G are divided and are disposed in the x-direction. Even though the structure is relatively complex, the third configuration example has the advantage that the semiconductor device becomes better in tracking high-frequency noise because the semiconductor device has a circuit configuration in which a plurality of capacitance elements C2 are connected in parallel.

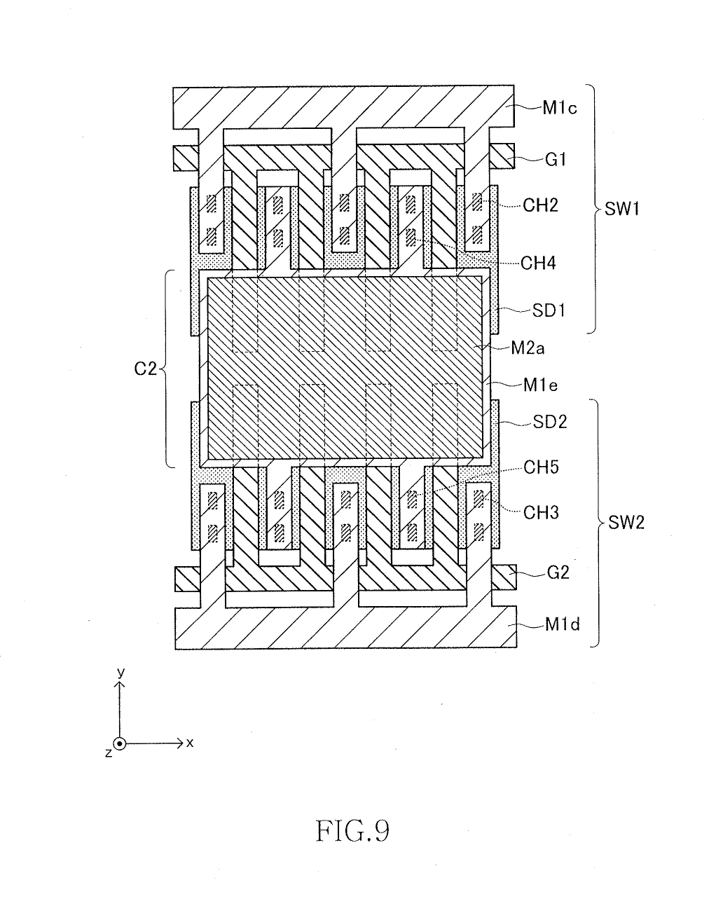

FIG. 9 is a schematic top view showing a first connection example of the capacitance element having the configuration shown in FIG. 6 with the switch elements SW1 and SW2. In the example shown in FIG. 9, the switch elements SW1 and SW2 each are made up of a plurality of transistors that are connected in parallel.

The switch element SW1 includes a plurality of source/drain diffusion layers SD1, which are alternately disposed; and a plurality of gate electrodes G1, each of which is disposed on a semiconductor substrate between the source/drain diffusion layers SD1. Among the source/drain diffusion layers SD1, a diffusion layer that functions as a source is connected to a conductive film M1c via a contact hole CH2. The conductive film M1c functions as the power-supply line VL1. Among the source/drain diffusion layers SD1, a diffusion layer that functions as a drain is connected to a conductive film M1e via a contact hole CH4.

Similarly, the switch element SW2 includes a plurality of source/drain diffusion layers SD2, which are alternately disposed; and a plurality of gate electrodes G2, each of which is disposed on a semiconductor substrate between the source/drain diffusion layers SD2. Among the source/drain diffusion layers SD2, a diffusion layer that functions as a source is connected to a conductive film Mid via a contact hole CH3. The conductive film Mid functions as the power-supply line VL2. Among the source/drain diffusion layers SD2, a diffusion layer that functions as a drain is connected to a conductive film M1e via a contact hole CH5.

On an upper layer of the conductive film M1e, a conductive film M2a is disposed and positioned so as to overlap in planar view, thereby forming the capacitance element C2. In this manner, the capacitance element C2 is so formed as to partially overlap with the switch elements SW1 and SW2. Therefore, the structure helps to reduce the size of the semiconductor device 100.

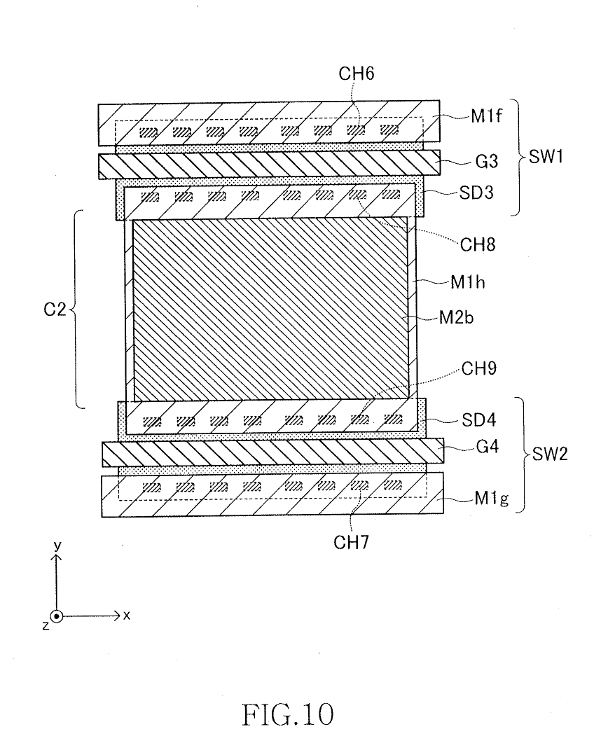

FIG. 10 is a schematic top view showing a second connection example of the capacitance element having the configuration shown in FIG. 6 with the switch elements SW1 and SW2. In the example shown in FIG. 10, the switch elements SW1 and SW2 are each made up of one transistor having a large channel width.

The switch element SW1 includes a source/drain diffusion layer SD3 and a gate electrode G3. The source diffusion layer is connected to a conductive film M1f via a contact hole CH6. The drain diffusion layer is connected to a conductive film M1h via a contact hole CH8.

Similarly, the switch element SW2 includes a source/drain diffusion layer SD4 and a gate electrode G4. The source diffusion layer is connected to a conductive film M1g via a contact hole CH7. The drain diffusion layer is connected to a conductive film M1h via a contact hole CH9. On an upper layer of the conductive film M1h, a conductive film M2b is disposed and positioned so as to overlap in planar view, thereby forming the capacitance element C2.

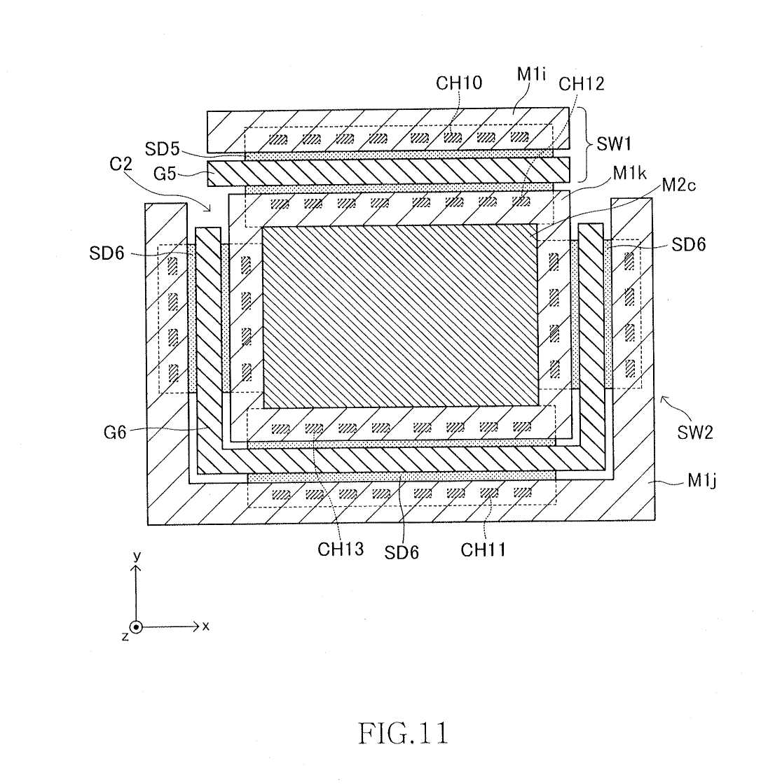

FIG. 11 is a schematic top view showing a third connection example of the capacitance element having the configuration shown in FIG. 6 with the switch elements SW1 and SW2. In the example shown in FIG. 11, the switch element SW2 includes a transistor that is so shaped as to encircle the capacitance element C2 from three directions.

The switch element SW1 includes a source/drain diffusion layer SD5 and a gate electrode G5. The source diffusion layer is connected to a conductive film M1i via a contact hole CH10. The drain diffusion layer is connected to a conductive film M1k via a contact hole CH12.

The switch element SW2 includes three source/drain diffusion layers SD6, which correspond to three sides of the capacitance element C2; and three gate electrodes G6. The source diffusion layer is connected to a conductive film M1j via a contact hole CH11. The drain diffusion layer is connected to a conductive film M1k via a contact hole CH13.

### Second Embodiment

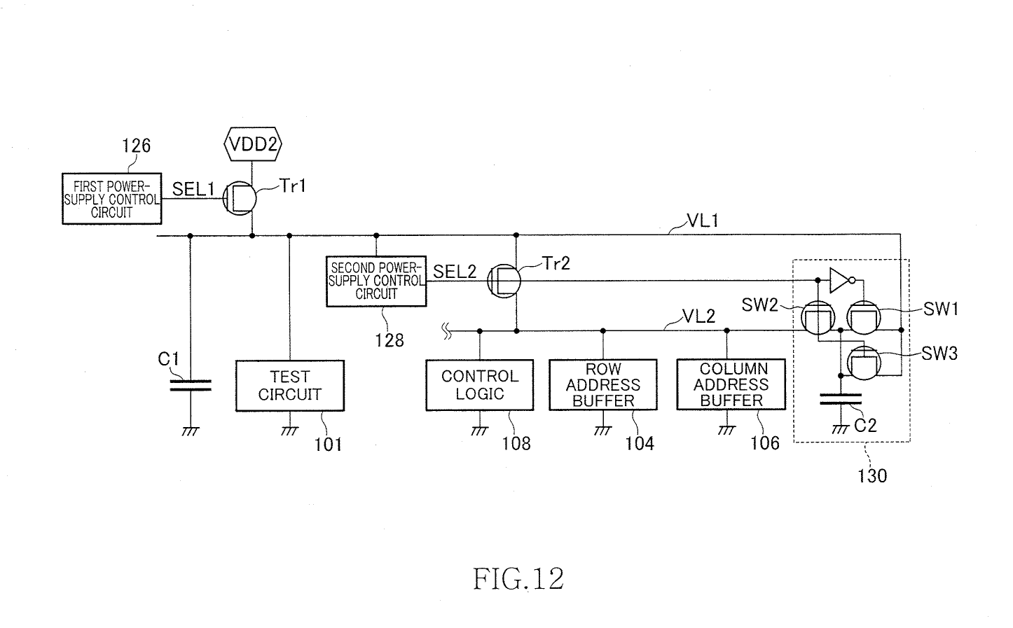

The second embodiment of the present invention will be explained with reference to FIG. 12. FIG. 12 is a diagram showing the capacitance control circuit 130 and peripheral circuits thereof according to the second embodiment of the present invention. In the second embodiment, the capacitance element C2 is connected to the power-supply line VL1 not only via the switch element SW1 but also via a switch element SW3. The capacitance element C2 is connected to the power-supply line VL2 via the switch element SW2. When the selection signal SEL2 is inactivated, i.e. when the clock enable signal CKE is inactivated, the switch element SW1 is turned ON, and the switch elements SW2 and SW3 OFF. When the power-on signal PON becomes activated as the power is turned ON, the capacitance element C2 is charged by voltage supplied from the power-supply line VL1. The procedure described above is almost similar to that of the first embodiment.

When the clock enable signal CKE is activated, the switch element Tr2 is then turned ON, the switch element SW1 OFF, and the switches SW2 and SW3 ON. The capacitance element C2 is connected to the power-supply line VL1 via the switch element SW3 instead of the switch element SW1.

After the potential VPERT is supplied to the power-supply line VL2, the charge and discharge of the capacitance element C2 takes place by absorbing power-supply noise. Usually, the charge and discharge is small. However, in some cases, the potential of the capacitance element C2 may temporarily fall. According to the second embodiment, the capacitance element C2 remains connected to the power-supply line VL1 via the switch element SW3. Therefore, the capacitance element C2 is appropriately charged through the power-supply line VL1 even after the switch element SW1 is turned OFF.

In this case, the transistor size of the switch element SW3, i.e. channel width, is smaller than the transistor size of the switch element SW1. That is, when the power is turned ON, the capacitance element C2 is quickly charged through the power-supply line VL1 via the switch element SW1 of a large transistor size. After the capacitance element C2 is fully charged, the capacitance element C2 is appropriately charged via the switch element SW3 of a small transistor size to compensate for a decline in potential that is associated with the discharge of the capacitance element C2. In this manner, the switch element SW3 is so designed as to have a small transistor size. Therefore, it is difficult for noise to propagate from the power-supply line VL2 to the power-supply line VL1.

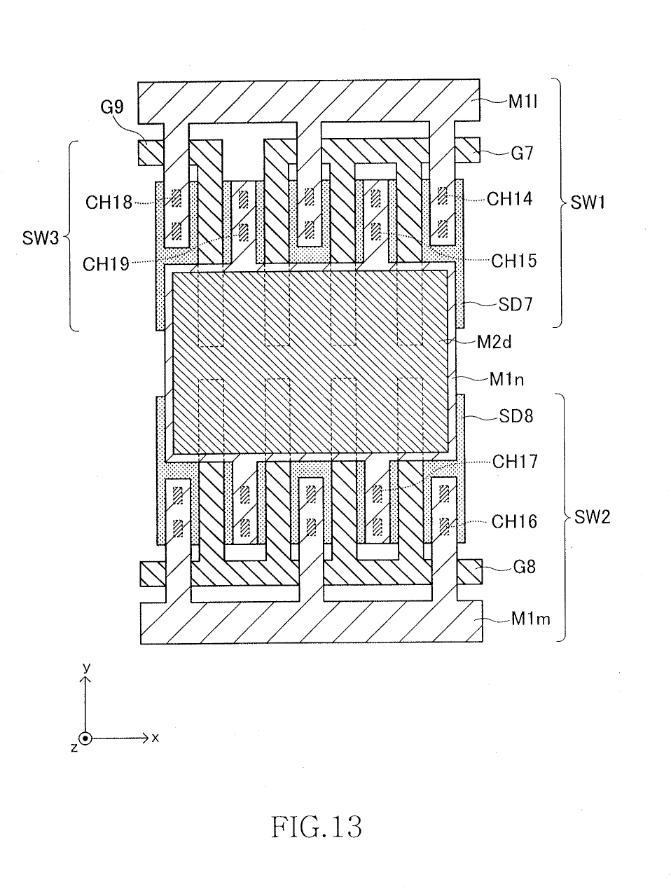

FIG. 13 is a schematic top view showing a connection example of the capacitance element having the configuration shown in FIG. 6 with the switch elements SW1, SW2 and SW3. In the example shown in FIG. 13, the switch elements SW1 and SW3 share a portion of a source/drain diffusion layer SD7.

The switch element SW1 includes the source/drain diffusion layer SD7 and a gate electrode G7. The source diffusion layer is connected to a conductive film M11 via a contact hole CH14. The drain diffusion layer is connected to a conductive film M1n via a contact hole CH15.

The switch element SW3 includes the source/drain diffusion layer SD7 and a gate electrode G9. The source diffusion layer is connected to the conductive film Mil via a contact hole CH18. The drain diffusion layer is connected to the conductive film M1n via a contact hole CH19. According to the above-described configuration, the switch element SW3's ability to supply current is substantially smaller than that of the switch element SW1. The reason is because a source/drain current flows through a plurality of sections via the comb-shaped gate electrode 7 in the switch element SW1, while a source/drain current flows only through one section via one gate electrode G9 in the switch element SW3.

The switch element SW2 includes a source/drain diffusion layer SD8 and a gate electrode G8. The source diffusion layer is connected to a conductive film M1m via a contact hole CH16. The drain diffusion layer is connected to a conductive film M1n via a contact hole CH17.

### Third Embodiment

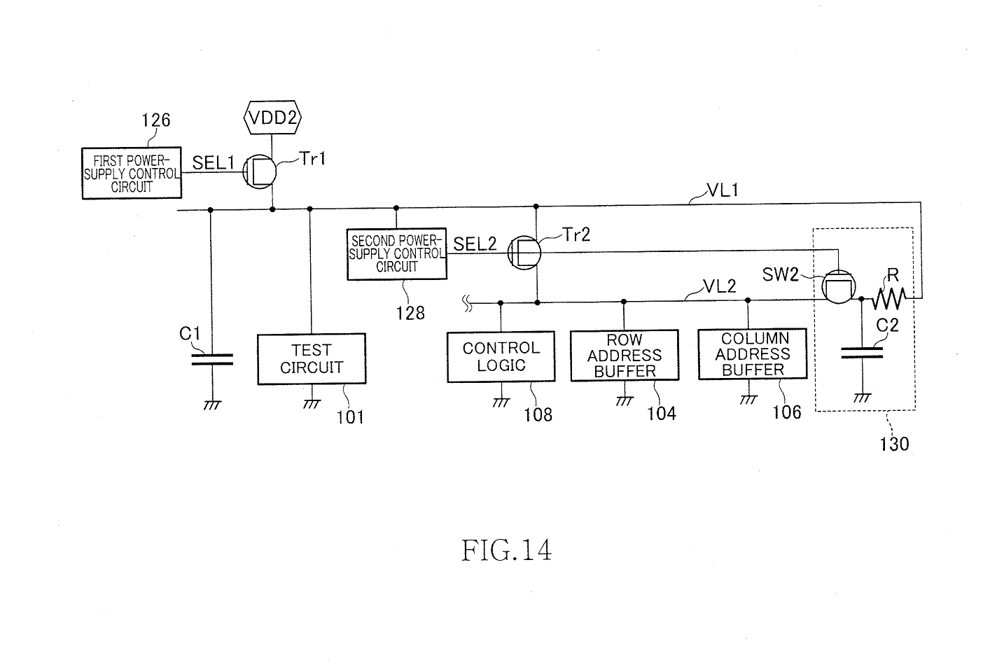

The third embodiment of the present invention will be explained with reference to FIG. 14. FIG. 14 is a diagram showing the capacitance control circuit 130 and peripheral circuits thereof, according to the third embodiment. According to the third embodiment, the capacitance element C2 is connected to the power-supply line VL1 via a resistance element R, not via the switch element SW1. The capacitance element C2 is connected to the power-supply line VL2 via the switch element SW2. Regardless of whether the selection signal SEL2 is activated or inactivated, the capacitance element C2 is charged by voltage supplied from the power-supply line VL1.

When the clock enable signal CKE is activated, the switch element Tr2 is then turned ON, and the switch element SW2 ON. Even if the discharge of the capacitance element C2 takes place as the potential of the power-supply line VL2 changes, the capacitance element C2 is appropriately charged because the capacitance element C2 is always connected to the power-supply line VL1 via the resistance element R. The advantage is that the number of switch elements in the third embodiment is smaller than in the first and second embodiments.

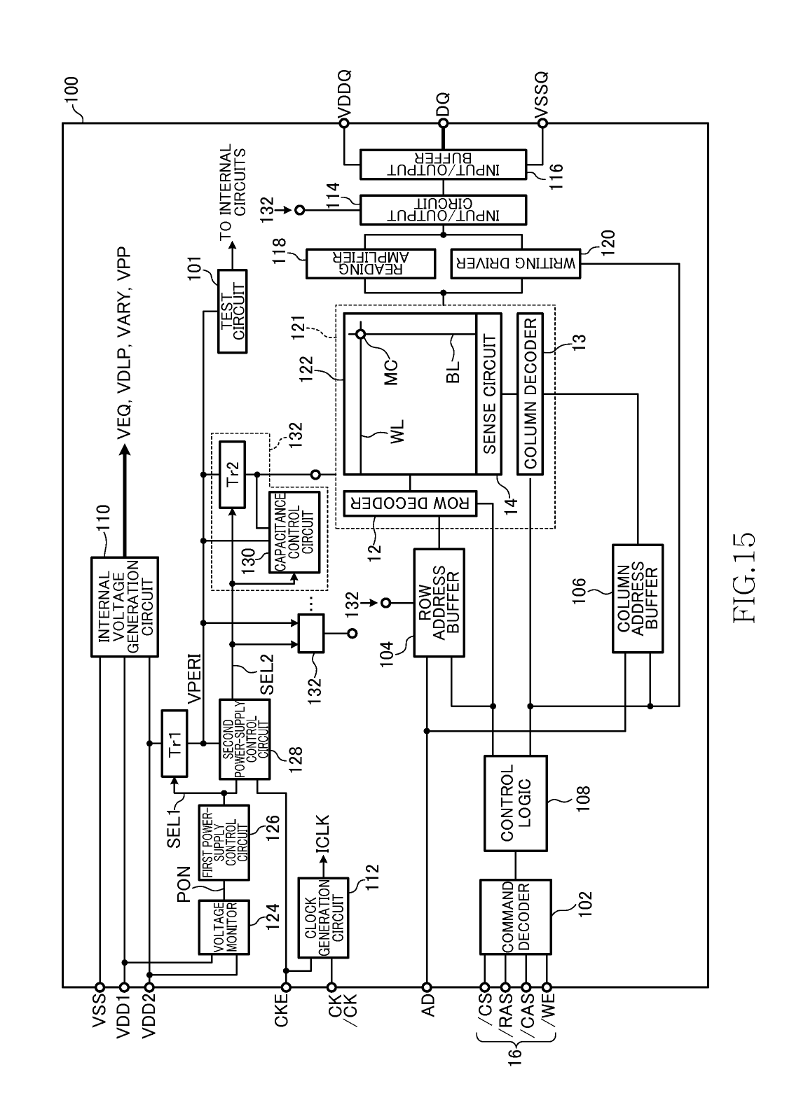

FIG. 15 is a functional block diagram of the semiconductor device 100 in a modification example. In the case of FIG. 1, a plurality of internal circuits are connected to a single power-supply line VL2; the connection of the power-supply line VL2 with the power-supply line VL1 is controlled by a single switch element Tr2; and a single capacitance control circuit 130 is assigned as compensation capacitor for the power-supply line VL2. In the case of FIG. 15, for the power-supply line VL1, a plurality of connection circuits 132, including the capacitance control circuit 130 and the switch element Tr2, are provided. Internal circuits, such as the control logic 108, the row address buffer 104, and the column address buffer 106, are each connected to the power-supply line VL1 via different connection circuits 132. Since power gating can be performed in more various ways, it is possible to reduce power consumption in an effective manner.

The above has described the semiconductor device 100 on the basis of the embodiments. According to the semiconductor device 100 of the present embodiments, compensation capacitor is connected to the power-supply line VL2 whose potential is controlled by the clock enable signal CKE, and it is possible to suppress a delay in the standby time of the power-supply line VL2.

It is apparent that the present invention is not limited to the above embodiments, but may be modified and changed without departing from the scope and spirit of the invention.

What is claimed is:

1. A semiconductor device comprising:
first and second power-supply lines;
a first switch element coupled between the first and second power-supply lines;
a capacitor element;
a second switch element coupled between the second power-supply line and the capacitor element; and
a first circuit electrically connecting the capacitor element to the first power-supply line when the first and second switch elements are in an OFF state.

2. The semiconductor device as claimed in claim 1, wherein the first circuit includes a third switch element coupled between the first power-supply line and the capacitor element and turned ON when the first and second switch elements are in the OFF state.

3. The semiconductor device as claimed in claim 2, wherein the first circuit further includes a fourth switch element coupled between the first power-supply line and the capacitor element and turned ON when the first and second switch elements are in an ON state.

4. The semiconductor device as claimed in claim 3, wherein the fourth switch element has smaller current supply ability than the third switch element.

5. The semiconductor device as claimed in claim 1, wherein the first circuit includes a resistor element coupled between the first power-supply line and the capacitor element.

6. A semiconductor device comprising:
a capacitor element coupled to a first power-supply line via a first switch element and coupled to a second power-supply line via a second switch element; and
a control circuit controlling the first and second switch elements, wherein
the control circuit turns the first switch element ON during a first period to connect the first power-supply line to the capacitor element, the first period being in which a power-supply voltage is supplied to the first power-supply line and is not supplied to the second power-supply line, and
the control circuit turns the second switch element ON during a second period to connect the second power-supply line to the capacitor element, the second period being in which the power-supply voltage is supplied to the first and second power-supply lines.

7. The semiconductor device as claimed in claim 6, further comprising:
a first external terminal supplied with an external voltage from outside;
a voltage monitoring circuit coupled to the first external terminal and activating a power-on signal depending on the external voltage of the first external terminal; and
a fourth switch element coupled between the first external terminal and the first power-supply line, the fourth switch element being turned ON in response to the activating of the power-on signal to supply the external voltage to the first power-supply line.

8. The semiconductor device as claimed in claim 7, further comprising
a second external terminal supplied with a clock enable signal from outside; and
a fifth switch element coupled between the first and second power-supply lines, the fifth switch element being turned ON in response to an activation of the clock enable signal to supply the external voltage from the first power-supply line to the second power-supply line.

9. The semiconductor device as claimed in claim 6, wherein the control circuit turns the first switch element ON and the second switch element OFF during the first period, and wherein the control circuit turns the first switch element OFF and the second switch element ON during the second period.

10. The semiconductor device as claimed in claim 6, wherein
the capacitor element is further coupled to the first power-supply line via a third switch element, and
the control circuit turns the first switch element ON during the first period to connect the first power-supply line to the capacitor element, and the control circuit turns the first switch element OFF and the third switch element ON during the second period to connect the first power-supply line to the capacitor element.

11. The semiconductor device as claimed in claim 10, wherein the third switch element is greater in an on-resistance than the first switch element.

12. A semiconductor device comprising:
a capacitor element coupled to a first power-supply line via a resistance element, and coupled to a second power-supply line via a second switch element; and
a control circuit controlling the second switch element, wherein
the control circuit turns the second switch element OFF during a first period to disconnect the second power-supply line from the capacitance element, the first period being in which a power-supply voltage is supplied to the first power-supply line and is not supplied to the second power-supply line, and
the control circuit turns the second switch element ON during a second period to connect the second power-supply line to the capacitance element, the second period being in which the power-supply voltage is supplied to the first and second power-supply lines in the second period.

13. The semiconductor device as claimed in claim 12, wherein the capacitor element is coupled to the first power-supply line without a switch element intervening between the capacitor element and the first power-supply line.
